(19) United States
(12) Patent Application Publication
(10) Pub. No.: US 2010/0001480 A1
(43) Pub. Date: Jan. 7, 2010

(54) Jersey liners

(75) Inventor: Victorene G. Forde, El Cajon, CA (US)

Correspondence Address: Victorene Forde, 248 Indiana Ave., El Cajon, CA, 92020, US

(73) Assignee: Victorene Forde

(21) Appl. No.: 12/321,064

(22) Filed: Jan. 15, 2009

Related U.S. Application Data
(60) Provisional application No. 61/011,224, filed on Jan. 17, 2008.

(51) Int. Cl. B62D 39/00

(52) U.S. Cl. 280/33.992

(57) ABSTRACT

The problem that this idea will solve is the fact that shopping carts are dirty. Carts are used by shoppers on a daily bases, people take them away from the stores and fill them with trash, cans and other personal items. Carts are picked up on the streets by individuals with trucks, hired by stores and dropped back to be used by shoppers. Unfortunately, these carts are never or hardly ever washed and sanitized. DO YOU KNOW WHERE YOUR SHOPPING CART HAS BEEN?

The specific group of people that will use this invention would be the general consumer populace, food specialty shops, American households, food markets, grocery stores, supermarkets, retail establishments and international markets.

Channels of distribution will be grocers/supermarkets, hardware stores, department stores, house wares stores, discount stores, home centers, convenient stores, malls, mail order & catalogue shopping, general merchandise retail, internet sites, TV infomercials and exports.

I invented Jersey Liners because I don't want anyone to suffer like I have in the past. I want to be sure that my grandbabies are safe when I let them ride in the shopping cart. I want to know that when I and other use the shopping carts, we are safe from germs and viruses that latch on to everything that touches a shopping cart. I want people to know that I care and they should care too.

### BRIEF DESCRIPTION OF SEVERAL VIEWS OF THE DRAWINGS

Jersey Liners are a specially designed sanitary liners configured specifically for use within retail shopping carts and hand baskets.

FIG. 1 is a perspective view of the sanitary liner in its present form in a frontal view.

FIG. 2 is a perspective view of the sanitary liner in its present form in a top view.

FIG. 3 is a perspective view of the Jersey liners logo with hidden sanitary wipe.

FIG. 4 is a partial perspective view of the seating area of the sanitary liner in a front.

FIG. 5 is a partial perspective view of the adhesive strip that covers the handle on the shopping cart.

FIG. 6 is a perspective view of the sanitary liner for the hand basket from a side view.

FIG. 7 is a perspective view of the sanitary liner for the hand basket from a top view.

### DESCRIPTION OF THE PREFERRED EMBODIMENT

### The Jersey Liners . . . are ‘Sanitary Liners’ for Retail Shopping Carts and Hand Baskets

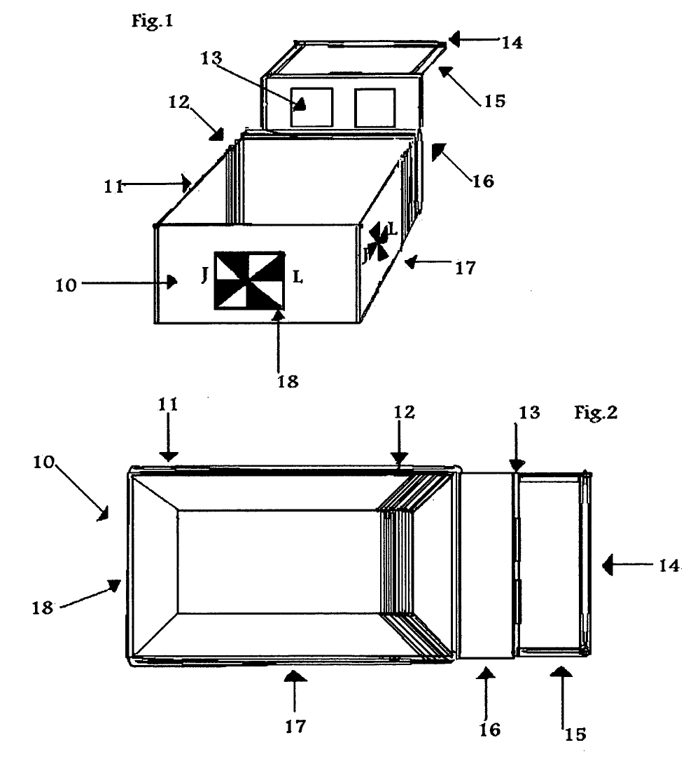

The invention of the Jersey Liners, are a specially designed sanitary liner 10 configured specifically for the use in retail shopping carts as shown in FIGS. 1 and 2. The perspective liners are easily installed within the basket of a shopping cart within the basket of a shopping cart. It provides an impenetrable barrier between the user's hands as well as the purchased goods from the germs and bacteria found on the handle and interior of the shopping cart.

Each liner 11, is comprised of sanitary paper, rectangular in shape, having two sides, a front and a back panel, also shown in FIGS. 1 and 2. The Jersey Liners have the ability to expand to any size basket 12 designed with ripples at the back end of the liner. In the seating are of the liners have leg holes 13 to sit a small child comfortably in cart.

Also, shown in FIGS. 1 and 2 is a peel away adhesive 14 which is used to secure the Jersey Liners to the cart. The two parallel strips 15 located at the back of the liners are designed to give full coverage on handles. A flexible seat cover 16 shown in FIG. 2 has the ability to fold inward for extra space in the basket. Moreover, it protects your fruits, vegetables and bread from contamination.

Jersey Liners are manufactured of a disposable sanitary paper material rectangular in shape or a reusable nylon or cotton material, also rectangular in shape and produced in a variety of sizes for small, medium, and large shopping carts. A sanitary wipe is folded inside the Jersey Liners logo 18 to wipe the handle of the cart before applying the adhesive.

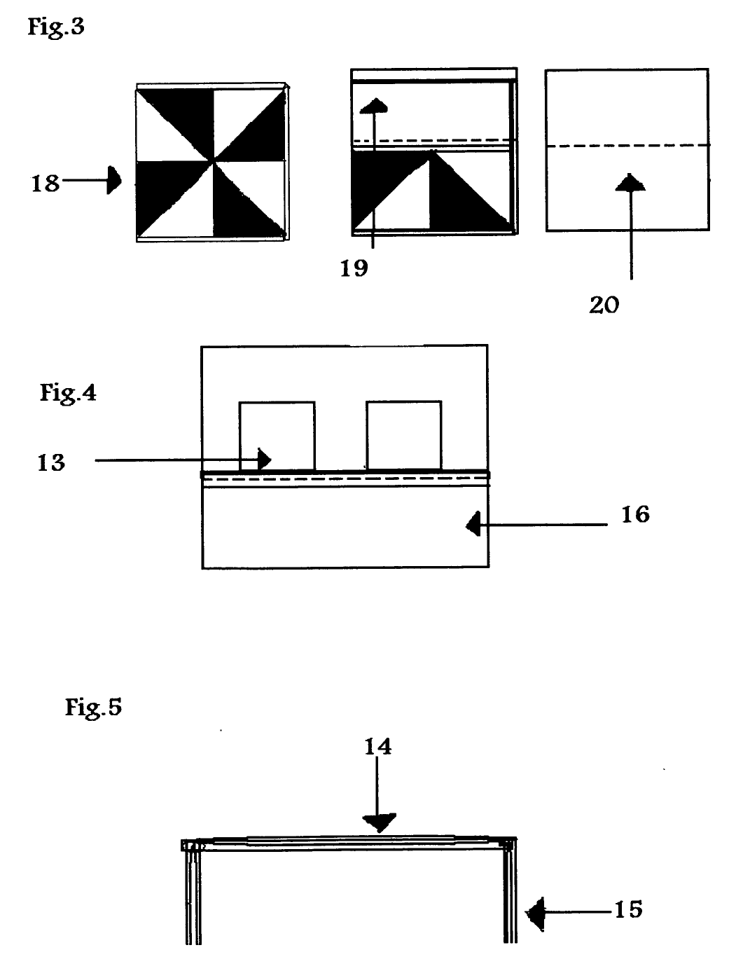

A perspective view of the Jersey Liners logo is shown in FIG. 3 a full view 18 of a packaged sanitary wipe, an opened logo pack 19, and a single sanitary wipe 20. Wipes are used to disinfect the shopping cart before liner is inserted. A perspective view of the seating area in FIG. 4 shows a separated section of the seating area with leg holes 13 for babies or toddlers and a sanitary seat cover 16 that protects the child or goods from lingering germs and viruses that thrive in shopping carts. FIG. 5 shows a partial view of the handle of the shopping cart 14 that is covered by the adhesive strip which prevents the spread of germs and viruses from cart to hand and from hand to carts. Moreover, a partial view of the adhesive strip that extends from the back upper partition of the cart to the handle.

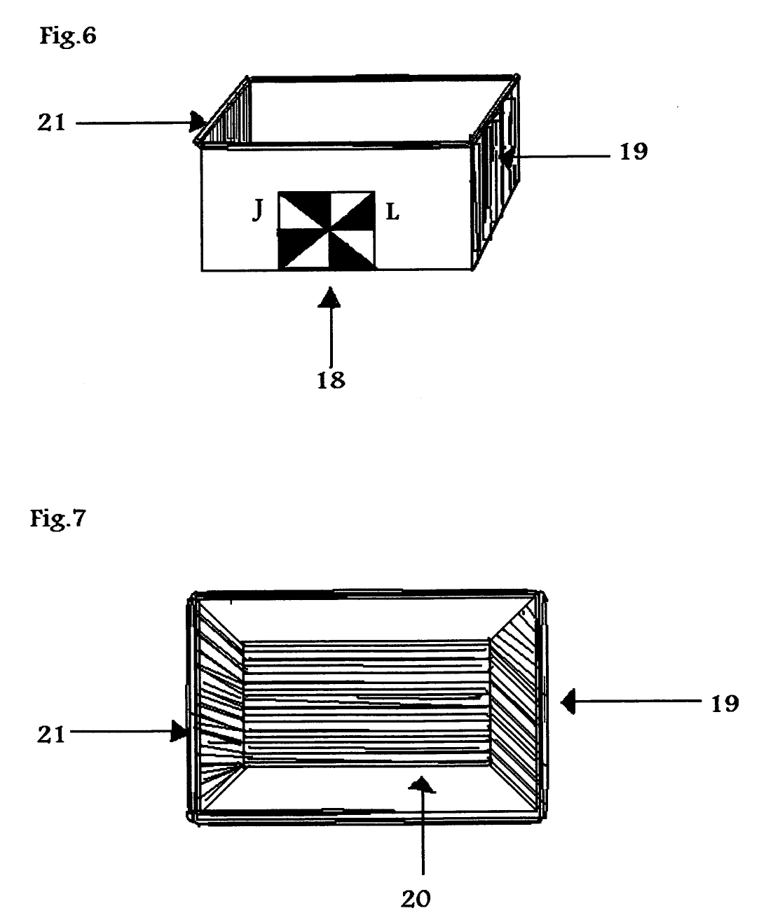

Finally, FIGS. 6 and 7 shows a perspective view of the smaller version of Jersey Liners specially designed for the hand baskets. A sanitary wipe is inserted into the Jersey Liners logo 18 to clean the handles of the basket. The side of the liners 19, and the bottom of the liners 20 are rippled to fit any size basket. Adhesive strips 21 are located at each end, front and back to hold the liner in place within the hand basket.

One never need to fear the germs of an uncovered cough, sneeze or accidental body fluids when these unique liners are used because they thwart the spread of germs and viruses from previous basket/cart users from being passed on to the subsequent cart/basket user. After the Jersey Liners have been used, it can be removed from shopping cart and placed in a recycling bin which can be processed into new liners or other paper products. Jersey liners protects the consumer as well as the environment.

1. Dimensions and characteristics are as follows:
A. Liners are rectangular in shape and will be fitted for any size shopping cart and shopping basket.
B. Liners are made of sanitary disposable paper which can be recycled.
C. Liners are made of reusable cotton fabric and secured with elastic banding.
D. A sanitary wipe will be attached to the logo of each liner for cart and basket.
E. Liners create a sanitary environment for shoppers.
F. The flexible seat cover folds inward for extra space in cart.
G. The peel away adhesive sticks to handle and secures each line to the cart.
H. A dispenser will be provided for easy access to shoppers
I. Jersey Liners cover the entire shopping cart within the basket to the handle.
J. Jersey Liners small liner, cover the inside of each hand basket.
The features that make this idea unique and appealing to the user is that it provides a sanitary environment for the shopper to put children, food, drink, clothing and other manufactured and personal items inside the shopping cart without fear of contamination from germs and viruses.
